(19) United States
(12) Patent Application Publication
(10) Pub. No.: US 2024/0173677 A1
(43) Pub. Date: May 30, 2024

(54) STEREOLITHOGRAPHY ADDITIVE MANUFACTURING OF ANION EXCHANGE MEMBRANE RESIN

(71) Applicant: Lawrence Livermore National Security, LLC, Livermore, CA (US)

(72) Inventors: Eric B. Duoss, Dublin, CA (US); Megan Ellis, San Francisco, CA (US); Sarah E. Baker, Dublin, CA (US); Nikola Dudukovic, Hayward, CA (US); Auston Louis Clemens, Livermore, CA (US); James Spencer Oakdale, Castro Valley, CA (US)

(21) Appl. No.: 18/071,363

(22) Filed: Nov. 29, 2022

(51) Int. Cl. B01D 67/00; B01D 71/40; B33Y 10/00; B33Y 70/00; B33Y 80/00

(52) U.S. Cl. CPC B01D 67/00045; B01D 71/401; B33Y 10/00; B33Y 70/00; B33Y 80/00; B01D 2323/40; B01D 2325/04; B01D 2325/16; B01D 2325/42; B01J 41/09

(57) ABSTRACT

A mixture for forming an anion exchange membrane includes a rigid monomer, an active monomer, and a polymerization initiator. The active monomer includes an acrylate group and a functional group selected from the following: a cation group, a halide group configured to be substituted with a cation group, or a leaving group configured to be substituted with a cation group.

This invention was made with Government support under Contract No. DE-AC52-07NA27344 awarded by the United States Department of Energy. The Government has certain rights in the invention.

### FIELD OF THE INVENTION

The present invention relates to additive manufacturing, and more particularly, this invention relates to stereolithography additive manufacturing of anion exchange membrane resin.

### BACKGROUND

World-wide energy consumption continues to grow despite rising concerns over environmental impacts and fossil fuel dependencies. There is increasing demand for new materials and improved energy storage technologies such as fuel cells, batteries, carbon capture and conversion, and environmental waste recycling to help address these issues.

Recent advances in fabrication technologies such as additive manufacturing (AM) or three-dimensional (3D) printing have enabled the production of bespoke, complex, and lightweight parts with significantly decreased geometric constraints, previously unachievable by traditional manufacturing approaches. In particular, AM methods such as stereolithography (SLA) and two-photon polymerization, produce complex structures with features on the order of 100 μm and 100 nm, respectively, by utilizing spatially controlled light to crosslink photocurable polymeric resins. As such, these technologies are capable of producing components featuring length scales relevant to renewable energy and recycling applications.

Rapid prototyping via AM has increasingly contributed to novel material discovery and bespoke component fabrication through reduced cost and rapid chemical turnaround. Examples of AM applied to electrochemical systems to optimize design and performance include fuel cells, microbial fuel cells, batteries, CO₂ electrolyzers, and membrane capacitive deionization cells. There is a sustained need for new 3D-printable materials to enable previously unachievable combinations of geometry and functionality in the energy sector.

Anion exchange membranes (AEMs) are a class of polymeric materials that contain covalently bound cation functional groups to facilitate the transport of anions. Anions can freely permeate through the membrane while cations are excluded by a combination of the Donnan effect and size exclusion as illustrated in FIG. 1. Protons can permeate through the membrane as well, but not large positively charged ions, such as positively charged metal ions, positively charged proteins, positively charged ions, etc. Key features sought in AEMs include high selectivity, low ionic resistance, and long-term mechanical and chemical stability. These properties can be tailored to meet requirements of the end use application. AEMs find use in a variety of systems including fuel cells, electrolyzers, electrodialysis, reverse electrodialysis (RED), membrane chromatography, wastewater treatment, acid recovery, and more. AEMs are typically produced by evaporation casting ionomers, such as ion containing polymers, into thin flat sheets, which limits their use to parallelly-stacked electrochemical devices. Recent manufacturing advancements have enabled the creation of profiled membranes.

Profiled membranes exhibit tunable surface features designed to enhance ion transport and, subsequently, are emerging as a competitive alternative to planar systems. Profiled membranes are typically manufactured through hot-pressing processes. Attempts to manufacture profiled membranes using 3D printing have included the use of sacrificial 3D printed molds.

Attempts to employ UV-sensitive resins for forming 3D products have demonstrated significant inefficiency with long cure times and low resolution that is not amenable to precise SLA processes. Moreover, formed structures demonstrate poor mechanical properties such as cracking or tearing during processing or under pressure in flow-through applications.

Methods remain elusive to engineer a tunable membrane structure formed by light-mediated processes that could elicit certain hydrodynamic and transport behaviors of a working fluid, such as an increased rate of mass transfer, which in turn may have a direct impact on membrane performance.

### SUMMARY

In one embodiment, a mixture for forming an anion exchange membrane includes a rigid monomer, an active monomer, and a polymerization initiator. The active monomer includes an acrylate group and a functional group selected from the following: a cation group, a halide group configured to be substituted with a cation group, or a leaving group configured to be substituted with a cation group.

In another embodiment, a product includes a printed three-dimensional structure including a polymer network having cationic functional groups to facilitate ion transport through the three-dimensional structure. The three-dimensional structure includes features arranged in a predefined geometric pattern, the features including walls having an average thickness in a range of greater than 5 μm to less than 150 μm.

In yet another embodiment, a method of forming a three-dimensional structure for transport of anions including obtaining a mixture comprising a rigid oligomer, an active monomer comprising an acrylate group and a halide group, and a polymerization initiator. The mixture is heated to reduce a viscosity of the mixture. A three-dimensional structure is printed by using an additive manufacturing technique to print the mixture to form a three-dimensional structure comprising a polymer network having a plurality of halide groups. The method further includes substituting halide groups in the polymer network with cation groups for functionalizing the polymer network for ion transport.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic drawing of anion exchange membrane for acid recovery.

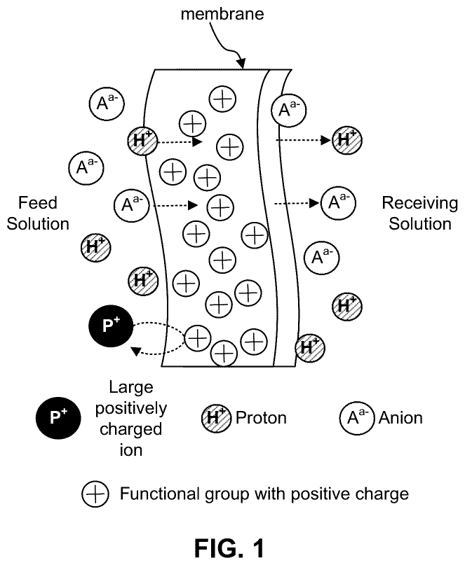

FIG. 2 is a series of images of three-dimensional structures, according to one embodiment. Part (a) is honeycomb structure held between fingers for size reference, part (b) is honeycomb structure having a wall thickness just above 100 microns, part (c) is a gyroid proximate to a penny for size reference, and part (d) is a gyroid structure having a wall thickness of just under 100 microns.

FIG. 3 depict examples of components of a mixture, according to one embodiment.

FIG. 4A is a flowchart of a method for forming a 3D structure for transport of ions, according to one embodiment.

FIG. 4B is a flowchart of another method for forming a 3D structure for transport of ions, according to one embodiment.

FIG. 5 depicts a series of schematic diagrams of a process, according to one embodiment. Part (a) is a diagram of a projection microstereolithography process, part (b) depicts a chemical reaction of quaternization of the polymer matrix, and part (c) depicts a process of anion exchange via the formed membrane.

FIG. 6 represents an application of forming a TPMS structure, according to one embodiment. Part (a) is a computational domain of simulated TPMS structures and a flow through of each structure in an apparatus, part (b) is a plot of the comparison of Sh number as a function of Re for each TPMS structure.

FIG. 7 represents considerations for formation of an apparatus, according to one embodiment. Part (a) is a plot of the comparison of IEC and conductivity of the membrane as a function of degree of cure, part (b) is a plot of the quantification of a critical thickness of a membrane, and part (c) is a schematic drawing of a critical thickness of a membrane.

FIG. 8 depicts properties of a membrane as a function of concentration of CLA in the mixture, according to one embodiment. Part (a) is a plot of measured in-plane chloride conductivity and IEC, part (b) is a plot of water uptake and swell ratio of the membrane, and part (c) is a plot of mechanical properties of tensile strength and Young's modulus.

FIG. 9 depicts characteristics of printing the mixture, according to one embodiment. Part (a) is a plot of a working curve of a 20% CLA to 80% DUDA formulation, part (b) is a plot of a line resolution curve at selected light doses, part (c) is an image of a 3D-printed anion exchange membrane in the shape of a square honeycomb, and part (d) is an image of a 3D-printed anion exchange membrane in the shape of a TPMS gyroid.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20°C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

A nanoscale, nanoporous, etc. is defined as having a diameter or length (e.g., a pore having an average diameter) less than 1000 nanometers (nm). A microscale, microporous, micron-sized, etc. is defined as having a diameter or length (e.g., a pore having an average diameter) less than about 1000 microns (μm).

It is also noted that, as used in the specification and the appended claims, wt. % is defined as the percentage of weight of a particular component relative to the total weight/mass of the mixture. Vol. % is defined as the percentage of volume of a particular compound relative to the total volume of the mixture or compound. Mol. % is defined as the percentage of moles of a particular component relative to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the resin, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

In addition, the present disclosure includes several descriptions of a “resin” used in an additive manufacturing process to form the inventive aspects described herein. It should be understood that “resins” (and singular forms thereof) may be used interchangeably and refer to a composition of matter comprising a plurality of oligomers, particles, small molecules, etc. coated with and dispersed throughout a liquid phase. In some inventive approaches, the resin may be optically transparent having a greater than 90% transmittance of light. In some inventive approaches, the resin is light sensitive where exposure to a particular light source changes the physical and/or chemical properties of the resin.

The following description discloses several preferred structures formed via photo polymerization processes, e.g., projection microstereolithography, photolithography, two-photon polymerization, etc., or other equivalent techniques and therefore exhibit unique structural and compositional characteristics conveyed via the precise control allowed by such techniques. The physical characteristics of a structure formed by photo polymerization processes may include fabrication of a solid micro-structure having complex geometric arrangement of ligaments, filaments, etc. The formation of a three-dimensional structure includes exposing a resin to light, where a pattern in the photoresist is created by the exposing light.

The following description discloses several preferred embodiments for a resin for forming an anion exchange membrane using stereolithography additive manufacturing and/or related systems and methods.

In one general embodiment, a mixture for forming an anion exchange membrane includes a rigid monomer, an active monomer, and a polymerization initiator. The active monomer includes an acrylate group and a functional group selected from the following: a cation group, a halide group configured to be substituted with a cation group, or a leaving group configured to be substituted with a cation group.

In another general embodiment, a product includes a printed three-dimensional structure including a polymer network having cationic functional groups to facilitate ion transport through the three-dimensional structure. The three-dimensional structure includes features arranged in a predefined geometric pattern, the features including walls having an average thickness in a range of greater than 5 μm to less than 150 μm.

In yet another general embodiment, a method of forming a three-dimensional structure for transport of anions including obtaining a mixture comprising a rigid oligomer, an active monomer comprising an acrylate group and a halide group, and a polymerization initiator. The mixture is heated to reduce a viscosity of the mixture. A three-dimensional structure is printed by using an additive manufacturing technique to print the mixture to form a three-dimensional structure comprising a polymer network having a plurality of halide groups. The method further includes substituting halide groups in the polymer network with cation groups for functionalizing the polymer network for ion transport.

A list of acronyms used in the description is provided below.
3D three-dimensional
AEM anion exchange membrane
AM additive manufacturing
CFD computational fluid dynamics
CLA 3-chloro-2-hydroxypropyl methacrylate
CO₂ carbon dioxide
DI deionized
DLP SLA digital light processing stereolithography
DUDA diurethane dimethacrylate
h hour
H₂O water
IEC ion exchange capacity
LAPμSL Large area projection microstereolithography
meq g⁻¹ equivalent units per gram
mJ millijoules
mL milliliters
MPa megapascal
mS cm⁻¹ milliSiemens per centimeter
mW milliwatt
nm nanometer
PDMS polydimethylsiloxane
PμSL projection microstereolithography
RED reverse electrodialysis
SLA stereolithography
TMA trimethylamine
TPMS triply periodic minimal surface
μm micron
UV ultraviolet
wt. % weight percent
WU water uptake

The following embodiments build upon the capability of manufacturing surface features to designing and printing fully formed 3D substrates enabling a large increase in design flexibility over previous manufacturing processes. Surface micropatterns provide an effective method of reducing resistance across the membrane. In devices that rely heavily on mass transport, profiled membranes (e.g., 3D-AEMs) offer promising performance features. In RED devices, spacers are added at the membrane stack interface to improve mass transport and reduce boundary layer size at the membrane surface. Direct surface patterning of conductive features via lithography techniques can eliminate problems associated with non-conductive spacers in electrodialysis stacks, resulting in significant performance improvements. For example, profiled membranes in RED may result in a 10% increase in net power density over that of similar systems with non-conductive spacers. Additionally, increased surface hydrodynamics offer additional antifouling capabilities.

According to embodiments described herein, surface patterned geometries explored through modeling efforts highlight increased mass transport and, subsequently, improve performance. Computational fluid dynamics (CFD) modelling has illustrated significant improvement in several heat transfer applications. Additive manufacturing provides opportunities to form 3D membranes with complex architectures, such as triply periodic minimal surface (TPMS) structures. TPMS structures have been utilized as heat exchangers due to their enhanced heat and mass transfer capability and mechanical integrity; and thus, are desirable candidates for thermal energy storage and carbon capture applications.

TPMS structures present an avenue of further improving mass transport in AEMs. The interdigitated but independent fluid channels present an ideal geometry for diffusion-based applications. The increased hydrodynamic transport in 3D membrane geometries of this type has so far only been realized through gas transport studies in polydimethylsiloxane (PDMS) membranes fabricated using sacrificial molds. Additional modelling of mass transport phenomena in TPMS structures is needed to elicit further development of complex 3D-printed membranes.

According to one embodiment, a product includes a printed 3D structure comprising a polymer network having cationic functional groups to facilitate ion transport through the 3D structure. The product may be configured to function as an anion exchange membrane. The 3D structure includes features arranged in a predefined geometric pattern. Features of a printed 3D structure include walls, struts, filaments, etc. The width of the features may be defined as a thickness, a diameter, etc.

In some approaches, the features of a 3D structure such as a gyroid include walls, preferably, self-supporting walls. The walls of the 3D structure may have an average thickness in a range of greater than 5 μm to less than 150 μm. In some approaches, the wall thickness may preferably be in a range of greater than 10 μm to less than 130 μm.

In some approaches, the features of a 3D structure such as a lattice may include struts, filaments, etc. The struts, filaments, etc. may have an average diameter greater than 5 μm to less than 150 μm. In some approaches, the average width (e.g., thickness, diameter, etc.) of the feature may be greater than 150 μm up to the millimeter range.

In various approaches, the 3D structure may have a geometric pattern that provides the 3D structure with a triply periodic minimal surface (TPMS). A TPMS has symmetries of a crystallographic group, such that the minimal surfaces have a crystalline structure repeating in three dimensions. TPMS are also free of self-intersections.

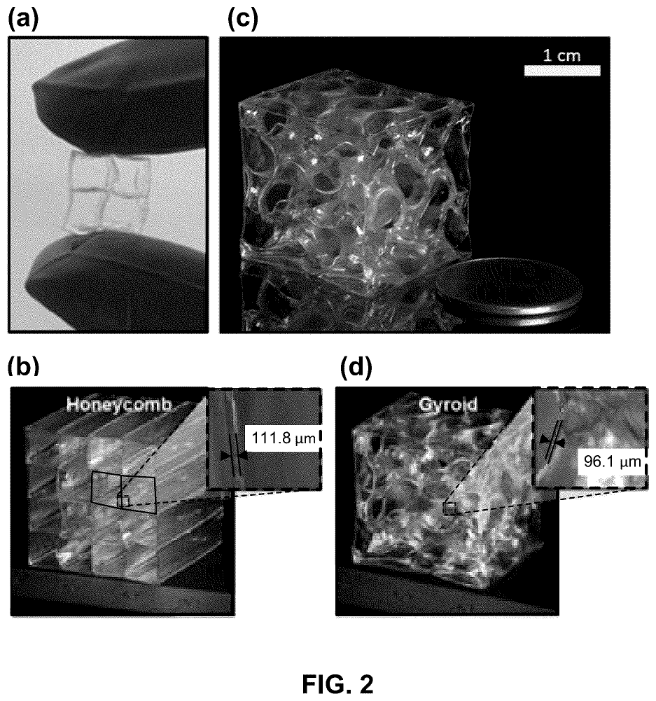

FIG. 2 depicts images of examples of a product, in accordance with one aspect of an inventive concept. As an option, the present product may be implemented in conjunction with features from any other inventive concept listed herein, such as those described with reference to the other figures. Of course, however, such product and others presented herein may be used in various applications and/or in permutations which may or may not be specifically described in the illustrative embodiments listed herein. Further, the product presented herein may be used in any desired environment.

Examples of printed 3D structures having predefined geometric patterns are shown in FIG. 2. The images of parts (a) and (b) illustrate a 3D structure having features (e.g., walls) printed in a square honeycomb geometric pattern. The thickness of the walls is about 100 μm (as shown 111.8 μm).

Parts (c) and (d) illustrate a 3D structure having features (e.g., walls) printed in a gyroid geometric pattern. The thickness of the self-supporting walls arranged in a gyroid pattern is about 100 μm (as shown 96.1 μm). The gyroid pattern, defined as providing a TPMS, has a three-fold rotational symmetry but no embedded straight lines or mirror symmetries.

In other approaches, a printed 3D structure may have geometric pattern that provides a Schwarz Diamond surface having two intertwined congruent labyrinths, each having a shape of an inflated tubular version of a diamond bond structure.

As described herein, a formulation of a mixture may be designed to be sufficiently mechanically robust for self-supporting complex architectures. For these features, a rigid oligomer may be included as the main oligomer base for its rigid like properties. An active monomer may be included for a high reactivity and ability to form cations due to the presence of a halide or other leaving group moiety. Purely acrylate based chemical constituents were chosen as 3D printing applications require high crosslink densities to enable spatially resolved curing under AM-relevant time scales (i.e., seconds per layer).

According to one embodiment, a formulation for an acrylate-based photocurable resin is used to print the 3D structure having a geometric pattern that provides a TPMS having wall thicknesses in the micron range. The formulation is a mixture for forming an anion exchange membrane. The mixture includes a rigid oligomer, an active monomer having an acrylate group and a functional group, and a polymerization initiator. In one approach, the functional group of the active monomer is a cation group. In another approach, the functional group of the active monomer is a halide group configured to be replaced by a cation group. In yet another approach, the functional group is a leaving group configured to be replaced by a cation group. The mixture may be configured as a resin for light-based stereolithography techniques and include a photoinitiator and a photoabsorber. The formulations are designed to be sufficiently mechanically robust for self-supporting complex architectures. In an exemplary approach, the formulation of the mixture is configured to form a geometric structure comprising features having walls between the features where the walls have an average wall thickness of about 130 μm or less.

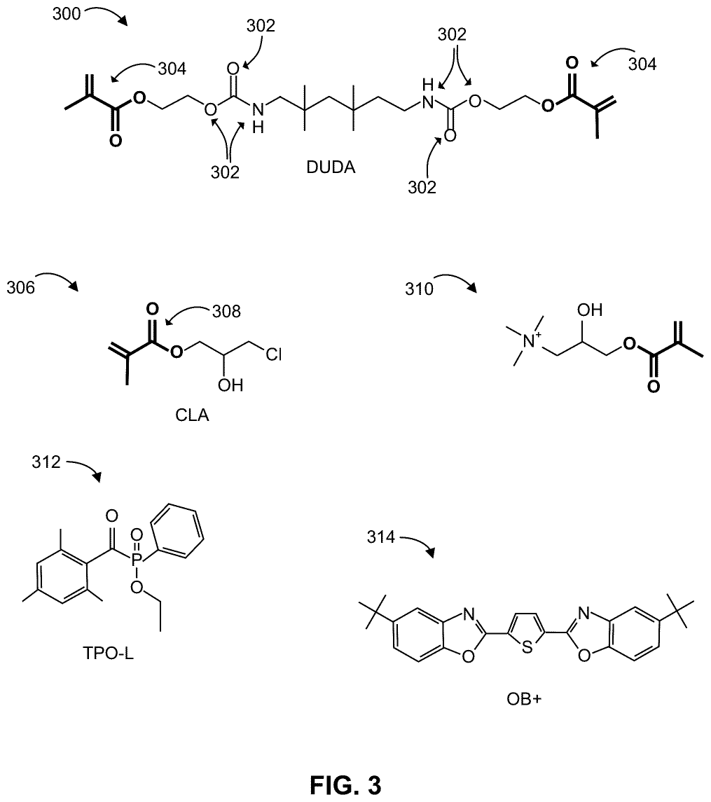

As described herein, the rigid oligomer brings stiffness into the polymer network of the structure after curing. In one example, the backbone of the rigid oligomer, as illustrated in the molecule 300 in FIG. 3, may have multiple polar substituents 302 that form a network of hydrogen bonding that contributes to the rigidity of the polymer matrix. In another example, the backbone of the oligomer may have polyaromatic substituents that contribute to the rigidity of the polymer matrix. Moreover, the rigid monomer may be prone to form crystalline domains that contribute to the rigidity of the polymer matrix. In a preferred approach, the rigid oligomer is a diacrylate oligomer. The molecule 300 has an acrylate group 304 (emboldened) at each end of the molecule 300 that participate in the crosslinking of the active monomer and the rigid oligomer into a polymer matrix during curing. In a preferred approach, the rigid oligomer is a diurethane dimethacrylate. In an exemplary approach, the rigid oligomer is diurethane dimethacrylate (DUDA), as illustrated as molecule 300. A rigid oligomer may be a polyfunctional acrylate oligomer that has a molecular weight greater than 100, greater than 200, greater than 400, etc.

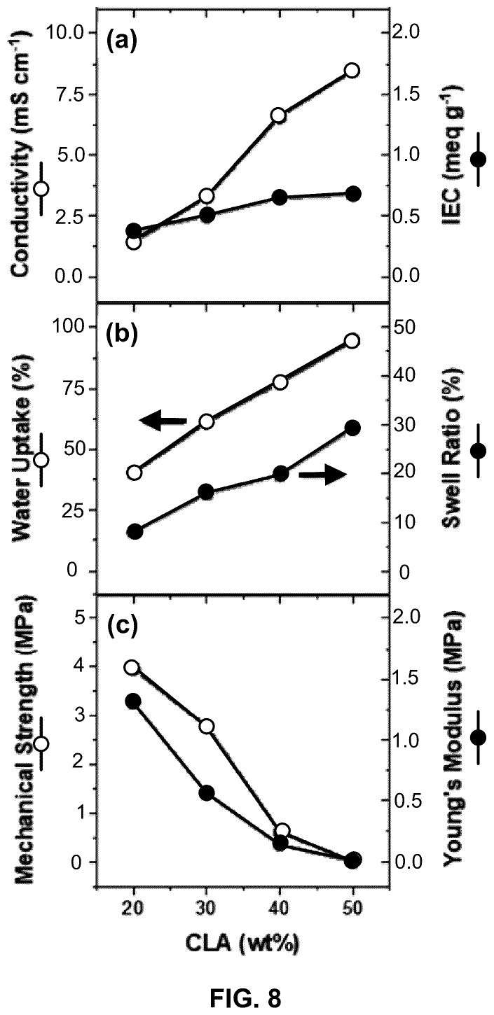

Without wishing to be bound by any theory, it may be understood that larger polymer chains have more flexibility and therefore are better able to accommodate water uptake and in turn, facilitate ion-channel formation. Polyfunctional acrylate formulations, on the other hand, are an ideal medium to rapidly generate glassy networks and are, unsurprisingly, commonly utilized in SLA resins. The resulting highly crosslinked networks lack the toughness observed in AEMs composed of high-molecular weight cation-functionalized polymers which likely have more flexible physical entanglements between larger polymer chains. In formulations having higher concentrations of active monomer (e.g., greater than 40 wt. % CLA), catastrophic failures of mechanical strength of the membranes in the form of cracking and crazing may be observed (see part (c) of FIG. 8).

As described herein, the active monomer includes an acrylate and a functional group configured to be replaced by a cation. In a one approach, the functional group of the active monomer is a halide group, for example a chloride group, a bromide group, etc. In yet another approach, the active monomer has a functional group that is a good leaving group to be replaced by a cation. The active monomer may be a methacrylate having a halide group (e.g., Cl, Br, etc.). In an exemplary approach, the active monomer is 3-chloro-2-hydroxypropyl methacrylate (CLA) 306, as illustrated in FIG. 3. The acrylate group 308 (emboldened) is a key functional group for the formation of the polymer matrix of the 3D printed structure. The active monomer may be configured to allow substitution of the halide group or other suitable leaving group familiar to those skilled in the art (e.g., Cl, Br, etc.) with a cation after a structure with the mixture is formed.

In another approach, the active monomer includes an acrylate and a functional group that is a cation group. For example, the active monomer is the CLA with a TMA group 310 substituted at the Cl group of the CLA molecule, e.g., 2-hydroxy-N,N,N-trimethyl-3-[(2-methyl-1-oxo-2-propen-1-yl)oxy]-1-propanaminium.

In yet other approaches, the active monomer may be a monomer with a cation functional group and an acrylate group with various size carbon links in between the cation functional group and the acrylate. The active monomer may be a monomer with various size carbon links between the acrylate group and the functional group (e.g., Cl, Br, etc.) that is configured to be substituted with a cation group.

Without wishing to be bound to any theory, it is believed that the acrylate groups on the rigid oligomer and the acrylate group(s) on the active monomer in combination with the photoinitiator and light are highly reactive resulting in high resolution of features printed using stereolithography techniques with light-mediated curing of layers within seconds (e.g., 1 to 2 second exposures). Moreover, the formulation allows formation of a mechanically stable structure having high aspect ratios that supported its own weight, e.g., a self-supporting structure. Moreover, these 3D printed structures formed with the acrylate-based formulation are able to take up water and support water networks while maintaining a mechanical integrity and ion transport capability.

In various approaches, a concentration of the active monomer relative to the rigid oligomer in the formulation may be determined based on the application of the formulation. In various approaches, material properties such as ion exchange capability (IEC), water uptake, conductivity, mechanical strength, etc. may be tuned by varying the concentration of the active monomer in the formulation before printing. For light-mediated SLA printing, a concentration of the active monomer may be in a range of about 5 wt. % to about 50 wt. % of the total weight of the combination of active monomer and rigid oligomer. The concentration of the rigid oligomer is complementary to the concentration of the active monomer. For example, a formulation having 5 wt. % of active monomer has 95 wt. % of rigid oligomer. In an exemplary approach, a formulation having 20 wt. % of active monomer includes 80 wt. % of rigid oligomer. Said another way, a ratio of the active monomer to the rigid oligomer in terms of weight may be in a range of 5:95 to 50:50.

The formulation includes a photoinitiator that is configured to initiate polymerization of the active monomer and rigid oligomer mediated by light during the printing process. In an exemplary approach, the photoinitiator is ethyl(2,4,6-trimethylbenzoyl)phenyl phosphinate (TPO-L) photoinitiator, as illustrated as TPO-L 312 in FIG. 3. In various approaches, the concentration of the photoinitiator may be in a range of 0.3 wt. % up to 1.0 wt. % of weight of total formulation. The concentration of photoinitiator may be configured for the process of forming a structure. In an exemplary approach of 3D printing a structure using light-mediated SLA techniques, a formulation of a resin may include 0.4 wt. % TPO-L relative to the weight of the total formulation. In a preferred approach of forming a planar, monolithic structure (e.g., a layer of resin poured between two glass slides), the mixture formulation may include 1.0 wt. % TPO-L relative to the weight of the total formulation.

The photoabsorber is included in the formulation to control the light penetration into the resin. In preferred approaches, a concentration of the photoabsorber may be in a range of greater than 0 wt. % to about 0.2 wt. % of weight if the total formulation of the mixture. In an exemplary approach, 2,5 Bis(5-tert-butyl-benzoxazol-2-yl)thiophene (OB+) (314 of FIG. 3) is included as a photoabsorber in the formulation.

In some approaches, the monomer components may include an inhibitor to promote the shelf-life of the monomers in the mixture before printing using stereolithography techniques. In an exemplary approach, 4-methyoxyphenol is included as an inhibitor in the formulation.

The AEM resin is tunable, and properties such as ion conductivity, water uptake (WU), and dimensional swelling can be controlled by varying the amount of CLA. The formulation supports high resolution SLA 3D printing of robust features at application-relevant scales (˜100 μm). We show that self-supporting TPMS structures can be printed to improve the membrane surface area per volume, flow properties, and rate of ion transport. This work provides a foundation for expanding AEM devices beyond planar geometries toward tunable and optimizable three-dimensional geometries.

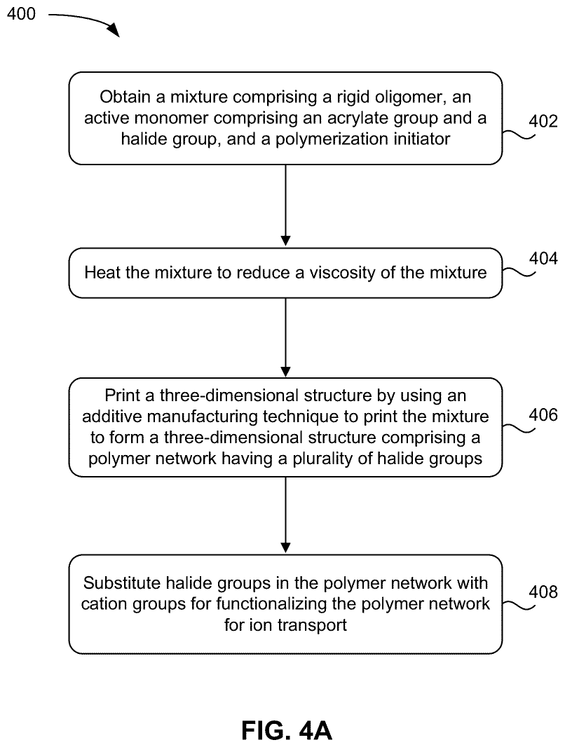

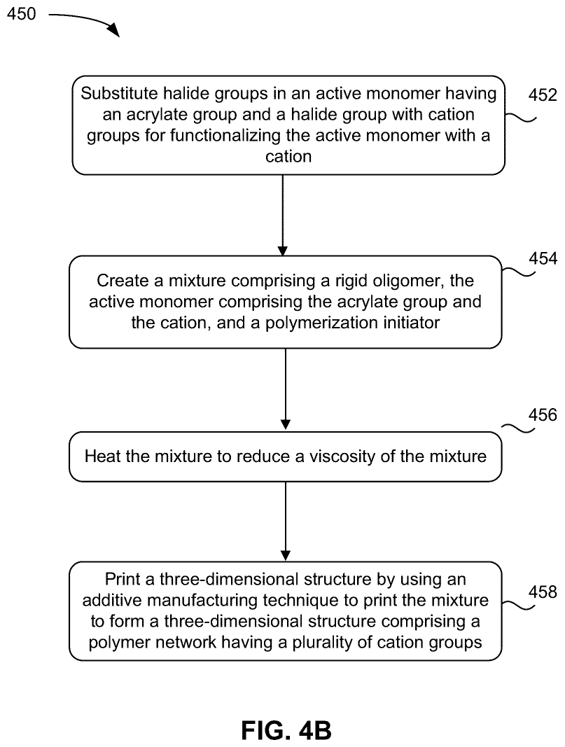

FIGS. 4A and 4B shows methods 400, 450 for forming a 3D structure for transport of anions, in accordance with one aspect of one inventive concept. As an option, the present methods 400, 450 may be implemented to construct structures such as those shown in the other FIGS. described herein. Of course, however, methods 400, 450 and others presented herein may be used to form structures for a wide variety of devices and/or purposes which may or may not be related to the illustrative embodiments listed herein. Further, the methods presented herein may be carried out in any desired environment. Moreover, more or less operations than those shown in FIGS. 4A and 4B may be included in methods 400, 450, according to various embodiments. It should also be noted that any of the aforementioned features may be used in any of the embodiments described in accordance with the various methods.

The method 400 of FIG. 4A may begin with operation 402 of obtaining a mixture comprising the formulation: a rigid oligomer, an active monomer, a photoabsorber, and a photoinitiator. The active monomer preferably includes an acrylate group and a halide group, as described herein. In an exemplary approach, the active monomer is 2-chloro-2-hydroxypropyl methacrylate (CLA) and the rigid oligomer is a diacrylate oligomer.

Operation 404 includes heating the mixture to reduce a viscosity of the mixture. Preferably, prior to use the mixture is heated to a temperature for a predefined duration of time to reduce viscosity and to improve draining between layers. In one approach, heating the mixture to 100° C. is preferred for reducing viscosity of the mixture. In another approach, a mixture that includes a quaternary cation before printing would preferably be heated at a lower temperature to improve viscosity without being detrimental to degradation. In preferred approaches, the resin bath (e.g., mixture) is kept at a constant temperature below 100° C. during printing (e.g., about 66° C.).

Operation 406 includes printing the three-dimensional structure by using an additive manufacturing technique to print the mixture to form a three-dimensional structure comprising a polymer network having a plurality of functional groups configured to form a cation. Using stereolithography AM techniques, a 3D printed structure using the mixture of rigid oligomer and active monomer may include a plurality of layers in which each layer is formed from a projected image pattern. 3D printing of a mixture allows light-mediated printing of features, walls, etc. in desired geometric patterns. The formulation as described herein allows formation of a layer of a 3D structure having features having a size on the order of 10 s of microns in a time duration of seconds before moving sequentially to the next layer. Complex geometric features may be rastered layer by layer using the formulation with SLA techniques.

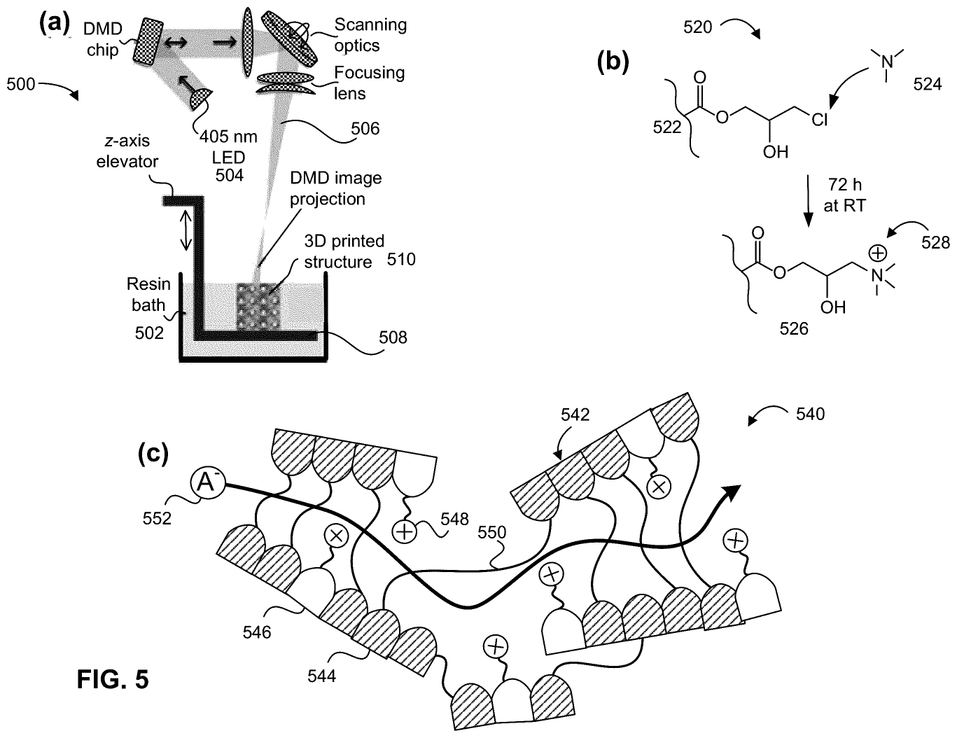

A 3D structure may be printed using the AM techniques known as digital light processing stereolithography (DLP SLA). As illustrated in part (a) of FIG. 5, the mixture (e.g., as a resin bath 502) may be printed on an AM technique that is a subset of DLP SLA, namely a Large Area Projection Microstereolithography (LAPμSL) printer 500 with a light source 504. In an exemplary approach, the LAPμSL light source rasters layer-by-layer projections 506 through a light path including a DMD chip, scanning optics, and a focusing lens over the build surface 508 to realize the polymerized solid 3D AEM structure 510. Printing and demonstration of triply periodic minimal surface (TPMS) structures may be chosen for their complex geometry and only achievable through additive manufacturing. In various approaches, physical characteristics of printing using DLP SLA techniques may include filaments arranged in a geometric pattern, a patterned outer surface defined by stacking filaments, a defined porosity (e.g., ordered, controlled, non-random, etc.), a porosity having pores with measurable average diameters, etc. Other complex geometric patterns, shapes, structures, etc. may be formed, for example, a honeycomb structure, a Schwartz Diamond surface, a gyroid, etc. Thus, using these DLP SLA techniques, such a LAPμSL, PμSL, etc. allows engineering of parts and production of optimal geometry for efficient mass transport and mechanical strength. The process of forming a 3D structure is highly scalable and compatible with 3D printing methods such as DLP SLA.

For a structure having a printed 3D shape, a thickness of the features (e.g., wall thickness) is preferably less than critical thickness of a planar AEM structure. For example, the walls of a 3D structure having a geometric pattern, e.g., gyroid, Schwartz-D surface, honeycomb, etc. have a thickness less than 170 μm. In an exemplary approach, a wall thickness of the 3D structure is less than 130 μm. AEM (functionalized with cations) having a wall thickness greater than 130 μm may result in abnormally high resistance due to an insufficient concentration of quaternary cations to support ion transport from one side of the membrane to the other.

During the printing of the structure, the mixture is cured by the light exposure to form a self-supporting structure comprising the polymer network. The initial curing of the light-mediated printing process forms a green body of the self-supporting structure.

In another approach, a 3D structure may be printed using extrusion-based AM techniques, such as Direct Ink Writing (DIW). In some approaches, a structure formed by DIW include a geometric arrangement of a continuous filament such as a lattice, a cylinder, etc. The composition of the mixture formulation may be tuned for optimal extrusion capability. DIW allows formation of a 3D structure using a continuous filament of the mixture (e.g., an ink). In one approach, the mixture may include a photoinitiator for polymerization of the mixture to form a polymer network after printing by exposure to UV light. In another approach, the mixture may include a thermal initiator for polymerization of the mixture to form a polymer network after printing by exposure to heat. The mixture may include an inhibitor to tune the extent of polymerization of the material.

In other approaches, the 3D structure may be printed using the mixture, resin, ink, etc. in a material jetting technique, such as ink jetting. These AM techniques are examples only and are not meant to be limiting in any way. AM techniques not described herein may be applied to the mixture, resin, ink, etc. as described. The formulation of the mixture, resin, ink, etc. may be tuned according to the desired AM technique for forming a 3D structure.

Referring back to FIG. 4A, operation 408 of method 400 includes substituting the halide functional groups in the polymer network with cation groups for functionalizing the polymer network for ion transport. In one approach, the halide groups may be substituted with cation groups by submerging the 3D structure in a cation solution. For example, the 3D structure may undergo quaternization by substituting Cl groups of the polymer network with amine group for an amount of time effective to effect the desired level of substitution.

In one example, membranes were submerged in a sealed container of a trimethylamine (TMA/H₂O) solution for 72 h at room temperature to form cations within the polymer network that facilitates ion transport. Part (b) of FIG. 5 illustrates the chemical reaction 520 of substituting the halide groups of the polymer network 522 with a cation 524 from a cation solution. In one approach the green body structure may be submerged in a cation solution such as trimethylamine (TMA) for substituting chlorine groups (Cl⁻) with ammonium (N⁺) groups. The green body structure may be submerged in the cation solution for up to 72 hours but may be a shorter duration of time or a longer duration of time, at room temperature. After quaternization, the polymer network 526 includes a cation 528 in the position previously occupied by a halide group.

Part (c) of FIG. 5 illustrates a schematic diagram of an example of an anion exchange membrane (AEM), according to one embodiment. The AEM 540 is comprised of a polymer network 542 that has polymer acrylate groups 544 and functionalized polymer acrylate groups 546 having a cation group 548. The polymer acrylate groups 544, 546 are crosslinked 550 to form the polymer network 542. An anion 552 is able to pass through the polymer network 542 by guidance and association with the cation groups 548.

As is common in SLA-based technologies, “green” parts are typically post-cured after the print process to achieve full mechanical integrity and consumption of unreacted acrylate groups. In typical light-mediated SLA processes, a post processing cure operation is included to complete the cure of the printed structure, such as exposing the green body of the structure to a UV light at temperature to complete the cure of the polymer network and to improve the crosslink density, e.g., the glassiness of the material. However, as described herein, a complete cure of green body having a polymer network before functionalization with cation group adversely affects the cation activity of the membrane structure. In an exemplary approach, the method of forming an AEM structure includes before functionalizing the polymer network with cation groups, curing the polymer network to a degree of cure less than 50%. In approaches where the degree of cure is greater than 60% the ion exchange capacity (IEC) and conductivity decrease significantly with increasingly aggressive cure conditions. The decrease in IEC may be attributed to increase crosslink density and subsequent glassiness of post-cured material which limits penetration depth of the cation solution and the ability for the cation molecule to penetrate into the polymer network and functionalize the polymer network is greatly hindered. In various approaches, the degree of cure relative to a decrease in IEC may depend on the parameters of the formulation of the mixture.

According to one embodiment, the method 450 of FIG. 4B includes beginning with an active monomer having an acrylate and a cation functional group. Operation 452 includes starting with an active monomer having an acrylate group and a halide functional group (or leaving group that may be substituted with a cation) and substituting the halide functional group with a cation group for functionalizing the active monomer with a cation group. An example of an active monomer having an acrylate and a cation functional group is illustrated in in FIG. 3 with the CLA substituted with a TMA group 310.

Returning to FIG. 4B, operation 454 includes creating a mixture that includes a rigid oligomer, the active monomer comprising the acrylate group and the cation, and a polymerization initiator. The formulation may be combined as described in method 400, FIG. 4A. Operation 456 of method 450 includes heating the mixture to reduce the viscosity of the mixture as appropriate for the desired AM technique to be employed for forming a 3D structure.

Operation 458 includes printing the 3D structure by using an AM technique to print the mixture to form a 3D structure comprising a polymer network having a plurality of cation groups. The method may employ any one of the AM techniques as described herein.

In one embodiment, in applications such as an electrochemical reactor, the printed 3D structure may be used as an ion exchange material. The material may be cured under a UV lamp to an extent that the polymer network is completely cured (i.e., a glassy material) such that the material is mechanically robust. The post-processing cure may be tuned according to the application environment of the 3D printed part having the functionalized polymer network.

The following combinations of resin formulations and subsequent printability into self-supporting TPMS structures at feature sizes on the scale of 100 μm has yet to been realized in previous technologies. At the relevant length scales, these complex AEM structures could be implemented into electrochemical devices to impart improved performance features such as increased mass transport by inducing hydrodynamic and transport behaviors at the membrane surface, as well as increase interfacial surface are per volume over planar stack devices.

### Experiments

### Mass Transport Modeling in TPMS Structures

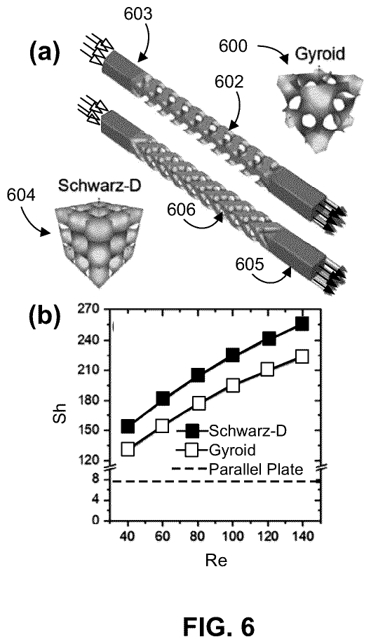

Computational Fluid Dynamics (CFD) numerical simulations were conducted on Gyroid and Schwartz-D TPMS structures using Ansys Fluent software as shown in FIG. 6. Using CFD modeling it was shown that there was a significant increase (about 30×) in mass in mass transport in TPMS geometries over planar configurations.

The computational domain of the simulated Gyroid 600 and Schwarz-D 604 structures are illustrated in part (a). The open arrows indicate an inlet boundary condition (BC), the black arrows are the outlet BC, the adjacent domains 603, 605 for the Gyroid 600, Schwarz-D 604 structures, respectively, are a no-slip BC with no species flux at the wall, and the middle domain 602, 606 for the Gyroid 600, Schwarz-D 604 structures, respectively, is the no-slip BC with a constant mass flux at the wall.

Part (b) of FIG. 6 is a plot that depicts the results from these simulations were then compared to the analytical solution for internal flow inside a parallel plate channel, which represents a standard planar membrane. Simulations were conducted on 1×1×10 unit cell structure. The Reynolds number (Re), Schmidt number (Sc), and Sherwood number (Sh) are non-dimensional numbers that are commonly used to characterize the flow and mass transport phenomena. The Re number represents the ratio between inertial and viscous forces, the Sc number corresponds to the ratio of momentum and mass diffusivity, and the Sh number represents the ratio of convective to diffusive mass transfer. These non-dimensional numbers were numerically calculated for the TPMS structures in Fluent using the following expressions:

Re=L_{c}U/v Equation 1

Sc=v/D Equation 2

Sh=L_{c}k̅/D Equation 3

where Lc is the characteristic length (i.e., hydraulic diameter), U is the flow velocity, [symbol] is the kinematic viscosity of water, D is the diffusivity of the injected species, and k̅ is the average mass transport coefficient.

$$\overline{k} = \frac{\frac{1}{A} {\int }_{A} D ∇ C \cdot n dA}{{C}_{w} - {C}_{bulk}} \qquad Equation 4$$

where C, C_{w}, and C_{bulk} are the concentration of the injected species, concentration at the channel wall, and bulk concentration (i.e., volume averaged concentration over the injection zone), respectively. n is the normal to the wall surface, and A is the area of species injection. The area A is depicted in part (a) of FIG. 6 at the middle domain 602 of the gyroid 600 structure and the middle domain 606 of the Schwarz-D 604 structure.

Simulations were conducted on one of the independent fluid domains, shown in the middle domain 602 of the gyroid 600 structure and the middle domain 606 of the Schwarz-D 604 structure in part (a) of FIG. 6. Numerical results and dimensionless parameters under identical conditions were solved to provide comparison in effective mass transport to that of internal fluid flow inside a parallel plate. Part (b) of FIG. 6 shows the numerically calculated Sh number as a function of Re for the Schwarz-D and Gyroid TPMS structures. The numerical results are compared with the analytical value of Sh number for a parallel plate flow channel. When taking into consideration the effect of Sc number, the predicted Sh values are consistent with Nusselt number (Nu) for similar TPMS simulations in heat transfer. The numerical results show a mass transfer enhancement of ˜30× in the TPMS structures, as compared to the parallel plate channel flow, representing a planar membrane. The improved mass transfer can be attributed to the continuous interruption of the boundary layer due to the tortuous flow path inside the TPMS channels. Moreover, a ˜16% increase in mass transport was observed with the Schwarz-D geometry as compared to the gyroid.

### Materials

Photocurable resin formulations were prepared but not limited to the following combination of chemicals: 3-chloro-2-hydroxypropyl methacrylate (CLA) and diurethane dimethacrylate (DUDA), mixture of isomers containing 225 ppm±25 ppm topanol as inhibitor, ≥97%, purchased from Sigma-Aldrich), ethyl(2,4,6-trimethylbenzoyl) phenyl phosphinate (TPO-L) photoinitiator, and 2,5-Bis(5-tert-butyl-benzoxazol-2-yl)thiophene (OB+) photoabsorber. 25 wt % TMA/H2O (purchased form Sigma-Aldrich) aqueous solution was used for post quaternization. Inhibitor, solvents, and other additives may be included in the formulation. Prior to use, the resin is heated at 100° C. and stirred for one hour to reduce viscosity.

### Planar and 3D Printed AEMs

For planar AEMs, photocurable resin formulations were prepared by mixing appropriate concentrations of CLA and DUDA. TPO-L photoinitiator was then added at 1 wt % and mixed with a vibrational mixer. The resin was then degassed in a vacuum oven for several minutes. The photocurable resin was then poured and binder-clipped in between two glass slides separated by a 100-μm thick silicone gasket. This assembly was then cured under a 3.0 mW cm⁻² 365 nm UV lamp for 30 s per side to provide a cumulative dose of 180 mJ cm⁻². The cured membrane was then peeled from the glass slide and washed with ethanol and water to remove excess unreacted monomer.

For 3D printed AEMs, the resin was printed on a LAPμSL printer with a 405 nm light source. The resin bath was held at 66° C. while printing. In one example, the LAPμSL light source administered an intensity of 125.2 mW cm⁻² and a layer-by-layer exposure time of 1.438 seconds was used for part fabrication, which corresponded to an energy dose of 180 mJ cm⁻². Applied UV dosage was held constant, to the extent possible, between planar and printed structures, albeit with different wavelengths, 365 vs 405 nm for the planar versus AM samples, respectively.

After completion, printed parts were allowed to drain and then rinsed with isopropyl alcohol to dissolve away uncured resin before being released from the printing substrate. SLA printing allowed manufacturability of complex geometries, which included square honeycomb and gyroidal TPMS structures.

Printing and demonstration of triply periodic minimal surface (TPMS) structures was chosen for their complex geometry (only achievable through additive manufacturing) and their application to increase mass transport relevant to several electrochemical device technologies.

Green-body planar and printed membranes were submerged in a sealed container of 25 wt. % TMA/H2O for 72 hours at room temperature. The quaternized membrane was then washed several times and soaked in DI water for 24 hours to remove residual TMA.

### Ion Exchange Capacity

The ion exchange capacity (IEC) was measured using Mohr titration. Sample was immersed in DI for 24 hours prior to titration. Sample (˜100 mg) were rinsed and submerged into 20 mLs of 1M NaNO₃ solution for 24 hours. Released NaCl was then titrated using 0.025 M AgNO₃ until an orange color persisted. IEC values were calculated using the dry mass of the membrane sample.

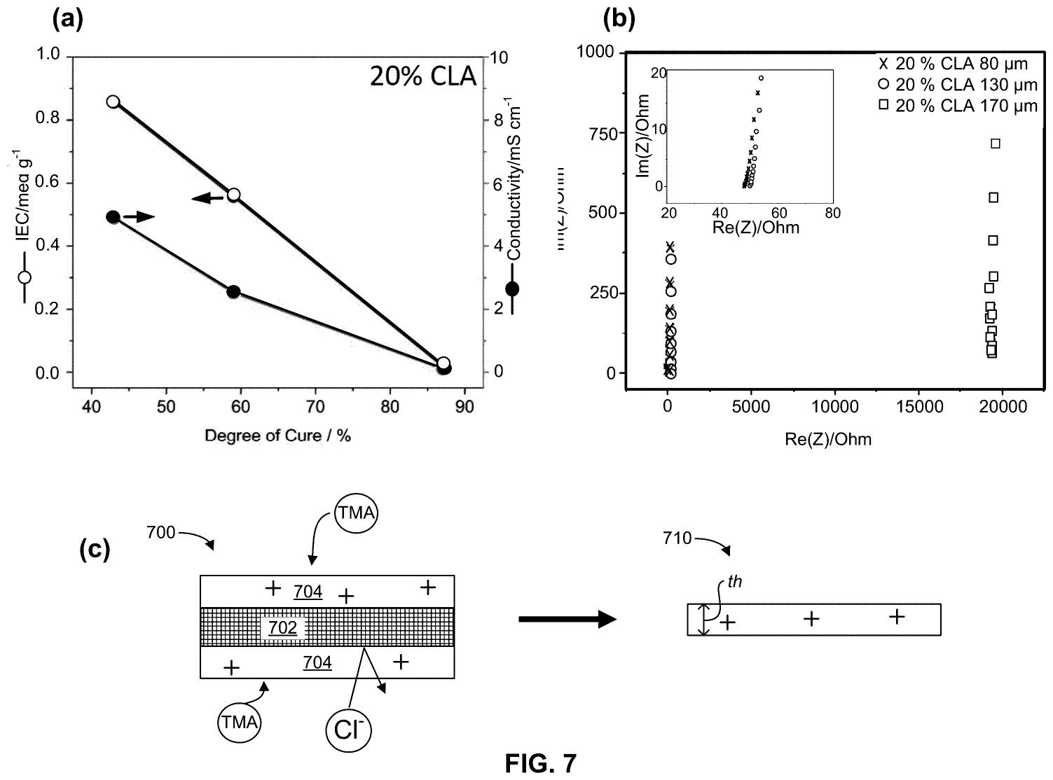

The degree of cure significantly affects the quaternization yield. As illustrated in part (a) of FIG. 7, a series of green planar membrane samples (prepared under UV light at 30 seconds per side) were subject to three different post curing conditions, 30 seconds at ambient temperature, 3 minutes at ambient temperature and 40 minutes at 70° C. in a Form Cure UV chamber (λ=365 nm). A decrease in IEC and conductivity was evident at increasingly aggressive curing conditions. The degree of cure that enables cation functionality of the membrane may be determined by the parameters of the formulation of the resin.

### Critical Membrane Thickness

A critical membrane thickness of the structure was assessed using through plane Cl⁻ conductivity measurements. Part (b) of FIG. 7 is an electrochemical impedance Nyquist plot for a series of planar membranes having different thicknesses, 80 μm, 130 μm, and 170 μm. A thickness less than 170 μm may be optimal thickness for ion transport, indicative of the abnormally high real ohmic resistance of the system. The schematic drawing in part (c) of FIG. 7 illustrates that a membrane 700 having a dead zone 702 where the TMA cation molecules may not penetrate to create a cationic environment, such that the cationic environment for anion transport is formed on the outer regions 704 of the membrane 700. The dead zone 702 may be formed for various reasons: the thickness of the membrane is too thick for efficient penetration of the cationic solution (e.g., TMA), the degree of cure is too high such that the polymer network is set, inaccessible by cation molecules, etc., the membrane is non-conductive, etc. Thus, in preferable approaches, a thickness th of the membrane 710 is preferably less than 130 μm but may be less than 170 μm. A membrane 700 having a thickness th less than critical thickness allows the movement of anions, demonstrates conductivity, etc.

### Properties of Material Formed With Varying Concentrations of Active Monomer

In one example, material properties were assessed of a planar membrane formed with formulation having different concentrations of an active monomer. FIG. 8 includes three plots that depict material properties of a membrane can be tuned by varying the concentrations of active monomer. The active monomer (e.g., CLA) content was varied to produce a range of IECs. The IEC, a measure of the concentration of charge within the membrane, is significant, as higher values can help facilitate transport of ions across the membrane. However, high IEC can also lead to high water uptake (WU), which in turn can result in high swelling ratios, larger dimensional changes, and possibly, loss of mechanical integrity. Despite low quaternization yield, IEC values (solid circles, right axis) could be tuned from 0.38 to 0.68 meq g⁻¹. as shown in part (a) of FIG. 8. Chloride conductivity (open circles, left axis) at 22° C. increases from 1.42 mS cm⁻¹ at 20% CLA to 8.47 mS cm⁻¹ at 50% CLA, as shown in the plot of part (a). Increases in conductivity may be attributed to the increased IEC, as well as to increased WU., as shown in the plot of part (b) of FIG. 8. WU (open circles, left axis) and dimensional swelling (solid circles, right axis) significantly increase as a function of CLA content.

As shown in part (c) of FIG. 8, mechanical strength of the membrane samples was significantly eroded at higher CLA concentrations. In addition, with 3D printed samples, increased concentrations of CLA resulted in reduced mechanical strength (not shown). The loss of mechanical integrity at higher CLA concentrations may likely be a result of several factors, including increased hydrophilicity of CLA-rich formulations, increased IEC, and reduced crosslink density at higher CLA content.

Alternate acrylate monomers were explored in the formulation process to improve mechanical properties and reduce WU. In one approach, a multifunctional crosslinker (dipentaerythritol penta/hexa-acrylate, DPEHA) was included as a likely candidate to enhance the degree of crosslinking and in turn, reduce WU and swelling. However, it was surprising that DPEHA had no significant effect on WU or dimensional stability. In another approach, a monofunctional methyl acrylate was also explored as an alternative to DUDA as a means to reduced crosslink density and produce networks with lesser free volume more akin to traditional membrane architecture (i.e., high molecular weight segments between crosslinks). However, this approach yielded samples that swelled excessively, which resulted in difficult-to-handle membranes that tended to fail mechanically prior to testing.

As described herein, membranes formed with a formulation having 20% CLA have a tensile strength of 3.69 MPa and Young's Modulus of 1.31 MPa. For comparison, non-crosslinked imidazolium-functionalized poly-phenylene oxide (PPO) based membranes, which can be considered as a standard AEM material, have tensile strengths of approximately 10 MPa at >2.5 meq g⁻¹ IEC. Commercial AEMs, such as PiperION, may feature tensile strengths exceeding 60 MPa. This comparison exemplifies a compromise in mechanical properties needed when formulating AEMs for additive manufacturing.

### Printing Process and Characterization

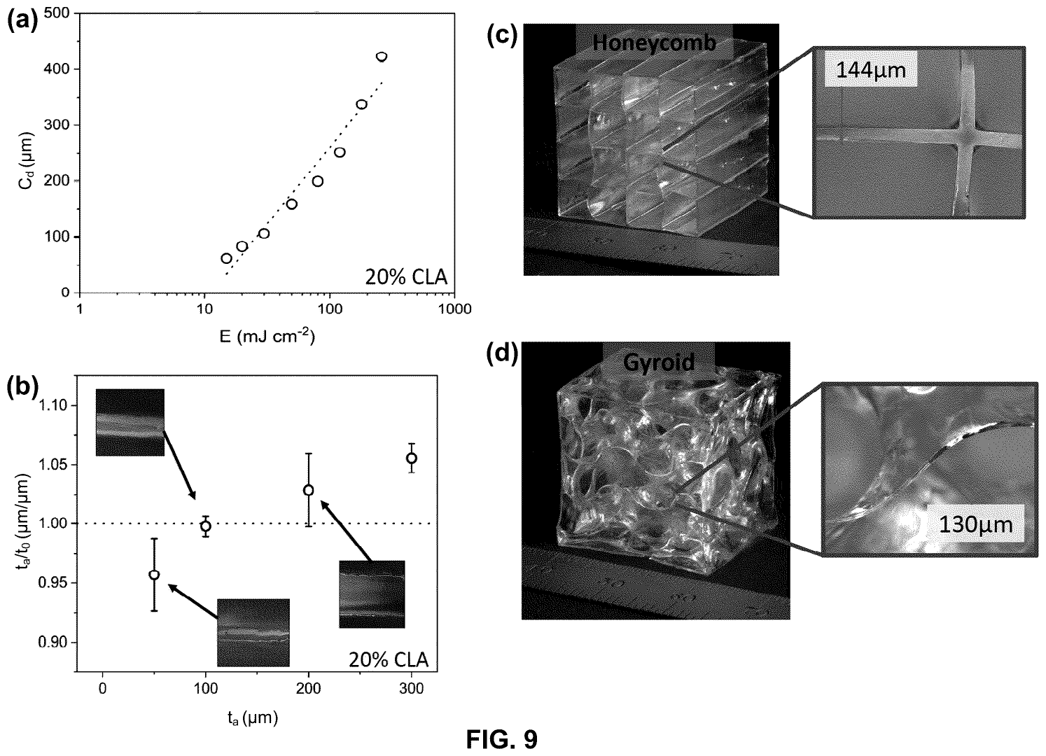

The working curve of the resin is an important parameter to establish print-conditions and includes the range of applied energy doses, Eₘₐₓ, and the resulting cure depths, C_{d}. The plot as shown in part (a) of FIG. 9 refers to the 3D printed AEM formed using a LAPμSL printer as described herein with a 405 nm light source Using the working curve relation (Equation 5), the critical energy dose, E_{c}, and the penetration depth, Dₚ, were determined to be 11.31 mJ cm⁻² and 119.6 μm, respectively.

$${C}_{d} = {D}_{p} ln ( \frac{{E}_{max}}{{E}_{c}} ) \qquad Equation 5$$

Successful polymerization requires that the applied energy dose must be greater than Ec and the layer thickness less than Dp. Test structures were printed, qualitatively examined for mechanical robustness, and measured for accuracy. A layer thickness of 10 μm and a light dose of 180 mJ cm⁻² were ultimately selected as the standard AEM resin print parameters.

Line resolution in the x-y plane was tested under these conditions by printing lines of varying widths ranging from 50 to 300 μm. The accuracy was evaluated by comparing the measured width of the printed line tₐ to the programmed width of the projected light line t₀ (part (b) of FIG. 9). The results show an error of less than 5% across was measured, demonstrating a highly accurate printing capability superior to many commercial resins printed using similar techniques, especially at these length scales.

Fully three-dimensional 20×20×20 mm³ structures with 100 μm thick walls were successfully printed, including a square honeycomb geometry consisting of four equally dimensioned rows and columns (part (c) of FIG. 9) and a TPMS gyroid structure (part (d) of FIG. 9). The resulting measured average wall thickness of the structures was 96.1 μm and 111.8 μm, respectively. The gyroid features were within the ˜5% error range predicted by the line resolution results, while the error of the honeycomb features approached that of commercial resins (˜12%). The line resolution prints were 2.5 mm tall (25 layers), while the actual structures were 20 mm tall (200 layers). It becomes apparent that the accuracy (in the x-y plane) is also dependent on the height of the feature, or more specifically, how many layers have been stacked consecutively, without spatial variation in the x-y plane of each layer.

### In Use

Various aspects of an inventive concept described herein may be developed for anion exchange membranes that are important components in many electrochemical reactors and separation devices, where they serve as a physical barrier that controls the selective transport of ions. Specific application of 3D printed AEMs may include but are not limited to fuel cells, electrolyzers, electrodialysis, reverse electrodialysis (RED), membrane chromatography, wastewater treatment, and acid recovery technologies.

The inventive concepts disclosed herein have been presented by way of example to illustrate the myriad features thereof in a plurality of illustrative scenarios, aspects of an inventive concept, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept but should be defined only in accordance with the following claims and their equivalents.

What is claimed is:

1. A mixture for forming an anion exchange membrane, the mixture comprising:
a rigid oligomer;
an active monomer comprising an acrylate group and a functional group selected from the group consisting of: a cation group, a halide group configured to be substituted with a cation group, and a leaving group configured to be substituted with a cation group;
a polymerization initiator.

2. The mixture as recited in claim 1, wherein the functional group is the cation group.

3. The mixture as recited in claim 1, wherein the functional group is the halide group selected from the group consisting of: chloride and bromide.

4. The mixture as recited in claim 3, wherein the active monomer is configured to allow substitution of the halide group thereof with a cation after a structure with the mixture is formed.

5. The mixture as recited in claim 1, wherein the active monomer is a methacrylate having a chlorine group.

6. The mixture as recited in claim 1, wherein the active monomer is 3-chloro-2-hydroxypropyl methacrylate (CLA).

7. The mixture as recited in claim 1, wherein the rigid oligomer is a diacrylate oligomer.

8. The mixture as recited in claim 1, wherein the rigid oligomer is diurethane dimethacrylate.

9. The mixture as recited in claim 1, wherein a concentration of the active monomer is in a range of about 5 wt. % to about 50 wt. % of the total weight of the active monomer and the diacrylate monomer.

10. A product, comprising:
a printed three-dimensional structure comprising a polymer network having cationic functional groups to facilitate ion transport through the three-dimensional structure,
wherein the three-dimensional structure comprises features arranged in a predefined geometric pattern, the features comprising walls, wherein the walls have an average thickness in a range of greater than 5 microns to less than 150 microns.

11. The product as recited in claim 10, wherein the three-dimensional structure is configured to function as an anion exchange membrane.

12. The product as recited in claim 10, wherein the geometric pattern provides the three-dimensional structure with a triply periodic minimal surface.

13. The product as recited in claim 10, wherein the geometric pattern is selected from the group consisting of: a honeycomb pattern, a gyroid pattern, and a Schwarz Diamond surface pattern.

14. A method of forming a three-dimensional structure for transport of anions, the method comprising:
obtaining a mixture comprising a rigid oligomer, an active monomer comprising an acrylate group and a halide group, and a polymerization initiator;
heating the mixture to reduce a viscosity of the mixture;
printing the three-dimensional structure by using an additive manufacturing technique to print the mixture to form a three-dimensional structure comprising a polymer network having a plurality of halide groups; and
substituting halide groups in the polymer network with cation groups for functionalizing the polymer network for ion transport.

15. The method as recited in claim 14, wherein the additive manufacturing technique is selected from the group consisting of: direct ink writing and digital light processing stereolithography.

16. The method as recited in claim 14, wherein the halide group is selected from the group consisting of chloride and bromide.

17. The method as recited in claim 14, wherein the active monomer is 3-chloro-2-hydroxypropyl methacrylate (CLA).

18. The method as recited in claim 14, wherein the rigid oligomer is a diacrylate oligomer.

19. The method as recited in claim 14, wherein the halide groups are substituted with the cation groups by submerging the three-dimensional structure in a cation solution.

20. The method as recited in claim 14, further comprising, before functionalizing the polymer network, curing the polymer network to a degree of cure that is less than 60%.
